(19) United States
(12) Patent Application Publication
(10) Pub. No.: US 2005/0178672 A1
(43) Pub. Date: Aug. 18, 2005

(54) Polishing method, polishing device, and method of manufacturing semiconductor equipment

(76) Inventors: Shuzo Sato, Kanagawa (JP); Takeshi Nogami, Kanagawa (JP); Shingo Takahashi, Kanagawa (JP); Naoki Komai, Kanagawa (JP); Kaori Tai, Kanagawa (JP); Hiroshi Horikoshi, Kanagawa (JP); Hiizu Ohtorii, Kanagawa (JP)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(21) Appl. No.: 10/512,205

(22) PCT Filed: Apr. 22, 2003
(86) PCT No.: PCT/JP03/05108

(30) Foreign Application Priority Data
Apr. 23, 2002 (JP) 2002-121333

(51) Int. Cl. B23H 3/00

(52) U.S. Cl. 205/651

(57) ABSTRACT

The object is to make it possible to pass an electric current to the object of polishing with a stable current density distribution up to the end point of polishing, to use the same plating apparatus, cleaning apparatus and other apparatuses as those conventionally used, and to carry out the conventional manufacturing process flow.

A substrate (1) provided with a metallic film (2) and a opposite electrode (3) are disposed oppositely to each other with a predetermined distance therebetween in an electrolytic solution, and an electric current is passed to the metallic film (2) through the electrolytic solution by an anode (4) set out of contact with the metallic film (2), so as to electropolish the metallic film (2). Simultaneously with the electropolishing, wiping is conducted by sliding a pad on the metallic film.

### CROSS REFERENCE TO RELATED APPLICATIONS

The present document is based on Japanese Priority Application JP2002-121333 filed to the Japanese Patent Office on Apr. 23, 2002, the content of which being incorporated herein by reference to the extent permitted by law.

### TECHNICAL FIELD

The present invention relates to a polishing method and a polishing apparatus for electropolishing a metallic film formed on a substrate by passing an electric current to the metallic film, and particularly to the layout of a current passing electrode for passing the electric current to the metallic film. The present invention relates also to a method of manufacturing a semiconductor device in which the polishing method is carried out during the manufacturing process.

### BACKGROUND ART

For such demands as smaller size, higher performance and a higher degree of multi-functions in electronic apparatuses such as TV sets, personal computers and cellular phones, a further enhancement of operating speed and a further reduction of power consumption have been requested in LSIs (Large Scale Integrations) used for these electronic apparatuses. To meet the demand for higher operating speed and lower power consumption in LSIs, miniaturization and conversion to multi-layer structure have been conducted in the manufacture of semiconductor devices and, in addition, optimization of materials has also been practiced.

In the field of semiconductor devices in which miniaturization has been progressing, a shift from the 0.1 μm generation, so-called in design rule, to the latter generations has been under way. In such circumstances, in the manufacturing process of semiconductor devices, planarization of surface is required in view of the limit in the depth of focus (DOF) on the exposure side attendant on the miniaturization, and, for achieving the surface planarization, chemical mechanical polishing (hereinafter referred to as CMP) process has been introduced and already widely generalized. The CMP is carried out for planarizing the wafer surface by removing surplus portions of a metallic film when the metallic film has been formed over the entire surface of a semiconductor wafer for filling up trenches, which are to be wiring trenches or contact holes or the like, with a metallic material to be metallic wirings, in the wiring forming methods represented by the dual Damascene process, for example.

From the viewpoint of wiring material, on the other hand, for the purpose of reducing the wiring delay whose contribution to operational delay has come to a non-negligible level due to the miniaturization of devices, a shift of the conductive metallic material for forming the wirings from the conventionally used aluminum to copper having a lower electric resistance has been under way after the 0.1 μm generation.

In addition, in the 0.07 μm generation, the combination of the above-mentioned copper wiring and a silicone oxide film based insulation film results in that device transistor delay is higher than wiring delay in the percentage of contribution to operational delay, and, therefore, improvements in wiring structure, particularly a further reduction in the dielectric constant of the insulation film is indispensable. For this reason, in the manufacture of semiconductor devices, the adoption of super-low dielectric constant materials such as porous silica with a dielectric constant of 2 or below has been investigated. However, the super-low dielectric constant materials such as porous silica are all low in mechanical strength, and the insulation films formed of the super-low dielectric constant materials would undergo collapse, cracking, exfoliation or the like under the process pressure of 4 to 6 PSI (i.e., 280 to 420 g/cm², because 1 PSI is equivalent to about 70 g/cm²) exerted in carrying out the conventional CMP, making it impossible to carry out favorable wiring formation. Besides, in the case where the pressure in the CMP is lowered to or below the pressure of 1.5 PSI (105 g/cm²) which the insulation films formed of the above-mentioned materials can endure, for preventing the collapse or the like from occurring, it is impossible to obtain a polishing rate required for the ordinary production rate. Thus, where a super-low dielectric constant material is used for the insulation film, many problems are involved in carrying out the CMP for planarizing the semiconductor wafer surface.

In view of the above, there has been proposed a polishing method by which the polishing rate required for the ordinary production rate can be obtained while using a low pressure by simultaneously carrying out electropolishing and wiping with a pad, instead of the above-mentioned CMP. In this method, an electric current is passed to a metallic film (for example, a copper film) on the semiconductor wafer surface which is the object of polishing, in the mode of using the metallic film as anode, and an electric current through an electrolyte is passed by supplying an electrolytic voltage between the metallic film and a opposite electrode which is a cathode disposed oppositely to the semiconductor wafer through an electrolytic solution, so as to electropolish the metallic film. By the electropolishing, the surface of the metallic film subjected to an electrolytic action as anode is anodically oxidized, with the result of formation of an oxide coating at the surface layer thereof. Furthermore, the oxide and a complex forming agent contained in the electrolytic solution react with each other, to form a denatured layer such as a high electric resistance layer, an insoluble complex coating and a passivated coating on the surface of the metallic film. Simultaneously with the electropolishing, the denatured layer is wiped with a pad, whereby the denatured layer is removed. In this case, only the denatured layer at the projected surface layer of the metallic film having unevenness is removed, to expose the metal therebeneath, while the denatured layer at the recessed surface layer is left as it is. Therefore, only the projected portions where the base (underlying) metal is exposed are re-electrolyzed and, further, are wiped, whereby the polishing of the projected portions proceeds. Such a cycle is repeated, whereby the semiconductor wafer surface is planarized.

In the above-mentioned polishing method, it is necessary to pass an electric current with the metallic film on the semiconductor wafer surface (which is the object of polishing) as anode, for carrying out the electropolishing. However, since the wiping is conducted by sliding the pad on the semiconductor wafer surface simultaneously with the electropolishing, a current passing electrode (anode) projecting on the wafer surface in such a manner as to impede the sliding motion of the pad cannot be disposed in a fixed state. In view of this, there may be contemplated a method in which a metallic film is formed up to the back side of the semiconductor wafer, and an electric current is passed via a wafer chuck coming into contact with the back side. Such a method, however, exerts great influences on the manufacturing process flow for the semiconductor device, such as contamination between itself and other apparatus at the time of handling, modifications in the method of forming the metallic film, etc.

Besides, in the electropolishing, such a current passing method as to provide a uniform current density distribution stably on the semiconductor wafer surface is required, since the polishing conditions and the polishing rate depend greatly on the current density. When electropolishing is conducted with an instable current density distribution in the case where the ratio of the area of the metallic film on the semiconductor wafer surface is reduced from the 100% state in which the metallic film is formed over the entire surface in the beginning of polishing to the state in which only the wiring patterns are left upon completion of the removal of surplus portions, there will occur such problems as corrosion or roughening of the surface of the metallic film upon the end point of polishing, generation of pits due to concentration of the electric current, etc. In addition, the difference in removal rate between the left large metal remaining portions or wide wiring portions and the independent narrow wiring portions would be increased due to concentration of dissolution rate on the narrow wirings, whereby the dissolution rate of the narrow wirings would be increased acceleratedly, leading to disappearance of the wirings. Thus, with the electropolishing under an instable current density distribution, it is difficult to form a favorable end point surface.

The above-mentioned problems may similarly occur also in the case where an electropolishing medium based on a CMP slurry containing abrasive grains and rendered electrically conductive is substituted for the electrolytic solution in carrying out the electropolishing.

Furthermore, since the metallic film to which the electric current is to be passed is itself the object of polishing in the above-mentioned polishing method, when the metallic film in the area where the electric current is passed by the current passing electrode is dissolved in advance, it becomes impossible to pass the electric current to the other areas where the metallic film still remains. Particularly, where a current passing electrode for passing an electric current by being slid in the vicinity of the peripheral edge of the semiconductor wafer is provided, electrolysis would be concentrated due to mechanical causes such as scratches, flaws, cuts, etc. and electrochemical causes such as sparks, electro-corrosion, etc. generated at the contact point between the current passing electrode and the metallic film, so that the contact point portion between the current passing electrode and the metallic film which should be left until the end point of polishing so as to perform the electropolishing over the entire surface might be dissolved precedingly. As a result, serious defects such as remaining of metal due to insufficient polishing, over-polishing, etc. would be generated, with the result of shortcircuit or opening of the wirings, or the formation of a surface which has a coarse surface roughness and an instable wiring electric resistance.

Accordingly, it is an object of the present invention to provide a polishing method and a polishing apparatus by which an electric current can be passed to the object of polishing with a stable current density distribution up to the end point of polishing, and further to provide a method of manufacturing a semiconductor device in which the polishing method is introduced into the manufacturing process and which makes it possible to use the same plating apparatus, cleaning apparatus and other apparatuses as those in the related art and to carry out the conventional manufacturing process flow.

### DISCLOSURE OF INVENTION

In order to attain the above object, according to the present invention, there is provided a polishing method including the steps of: disposing a substrate provided thereon with a metallic film and a opposite electrode oppositely to each other with a predetermined interval therebetween in an electrolytic solution; and passing an electric current to the metallic film through the electrolytic solution by a current passing electrode set out of contact with the metallic film so as to electropolish the metallic film.

In addition, according to the present invention, there is provided a polishing apparatus including, in an electrolytic solution: a substrate provided thereon with a metallic film; a opposite electrode disposed oppositely to the substrate with a predetermined interval therebetween; and a current passing electrode set out of contact with the metallic film, wherein an electric current is passed to the metallic film through the electrolytic solution by the current passing electrode so as to electropolish the metallic film.

In the polishing method and the polishing apparatus according to the present invention as mentioned above, an electric current is passed to the metallic film through the electrolytic solution by the current passing electrode set in the state of being out of contact with the metallic film, to thereby perform electropolishing. Therefore, in the present invention, the current passage portion of the metallic film opposite to the current passing electrode acts as a cathode, on which electrons are concentrated and the cations in the electrolytic solution are deposited. In addition, since the current passing electrode is out of contact with the metallic film, there would not occur the problem that flaws or the like might be generated due to contact or sliding between the current passing electrode and the metallic film, the electrolysis might be concentrated on the flawed portions, and the current passage portions might be dissolved precedingly. Therefore, according to the present invention, it is ensured that the electropolishing proceeds favorably up to the end point of polishing, and such problems as remaining of the metallic film, over-polishing, etc. are prevented from being generated.

In addition, in the present invention, wiping is conducted simultaneously with the above-mentioned electropolishing. A pad to be used at the time of the wiping is smaller in diameter than the metallic film, and the current passing electrode is disposed at a peripheral edge portion of the metallic film protruding outwards from the area of the pad. Therefore, even through the current passing electrode is disposed on the side of the surface to the polished, it does not hinder the wiping, and the electropolishing and the wiping are conducted simultaneously and favorably.

Besides, according to the present invention, there is provided a method of manufacturing a semiconductor device, including the steps of: disposing a wafer substrate and a opposite electrode oppositely to each other with a predetermined interval therebetween in an electrolytic solution, the wafer substrate being provided thereon with a metallic film formed of a metallic wiring material so as to fill up connection holes or wiring trenches formed in an inter-layer insulation film or both of the connection holes and the wiring trenches; and passing an electric current to the metallic film through the electrolytic solution by a current passing electrode set out of contact with the metallic film so as to electropolish the metallic film.

In the method of manufacturing a semiconductor device according to the present invention, like in the above-mentioned polishing method, the electropolishing proceeds favorably up to the end point of polishing, such problems as remaining of the metallic film and over-polishing are prevented from being generated, and the electropolishing and the wiping are performed simultaneously and favorably. As a result, according to the present invention, such defects as shortcircuit and opening of the metallic wirings are restrained from being generated, and a surface which is smooth and has a stable wiring electric resistance is formed. In addition, unlike in the case of, for example, forming a metallic film also on the back side of the wafer substrate and passing an electric current from the back side, it is unnecessary to take into account contamination between the metallic film and other apparatuses, modifications in the method of forming the metallic film or the like, and it is possible to manufacture a semiconductor device by using the same film forming apparatus and post-polishing cleaning apparatus as those conventionally used and following the conventional semiconductor device manufacturing process flow.

Furthermore, in the present invention, the current passing electrode is set out of contact with the metallic film, and the inter-layer insulation film is not pressed at the time of passing an electric current. Therefore, according to the present invention, breakage of the inter-layer insulation film such as exfoliation and cracking is prevented from occurring and a favorable wiring formation is realized, even in the case where a low-strength low dielectric constant film formed of a low dielectric constant material such as porous silica is used as the inter-layer insulation film.

### BRIEF DESCRIPTION OF DRAWINGS

FIG. 1 illustrates layout of an electrode for electropolishing carried out in the polishing method according to the present invention.

FIGS. 2A to 2E illustrate the method of manufacturing a semiconductor device according to the present invention, and are vertical sectional views for illustrating the steps ranging from the formation of an inter-layer insulation film to the formation of a Cu film for filling up wiring trenches and contact holes with a metallic material.

FIGS. 3A to 3D illustrate a polishing step in the manufacturing method.

FIG. 4 is a side view of the polishing apparatus according to the present invention.

FIG. 5 illustrates the layout position of an anode in the polishing apparatus and the sliding condition of a pad.

FIG. 6 is a plan view of a semiconductor wafer, showing a current passage area for the Cu film.

FIG. 7A is a side view showing an anode portion of the polishing apparatus.

FIG. 7B is a bottom view showing the anode portion of the polishing apparatus.

FIG. 7C is a back elevation showing the anode portion of the polishing apparatus.

FIG. 8 illustrates a levitated condition of the anode portion.

FIG. 9A is a side view showing the general configuration of a polishing apparatus having another configuration.

FIG. 9B is a plan view showing the general configuration of the polishing apparatus having the another configuration.

FIG. 10A shows a further configuration of the apparatus.

FIG. 10B shows yet another configuration of the apparatus.

FIG. 11A is a side view showing the general configuration of a polishing apparatus having still another configuration.

FIG. 11B is a plan view showing the general configuration of the polishing apparatus having the still another configuration.

FIG. 11C is a sectional view along line A-A of FIG. 11B, showing the general configuration of the polishing apparatus having the still another configuration.

FIG. 12A is a side view showing the general configuration of a polishing apparatus having a still further configuration.

FIG. 12B illustrates the position of an anode portion and the movements of a pad in the polishing apparatus having the still further configuration.

### BEST MODE FOR CARRYING OUT THE INVENTION

Now, an information transmission system and an information transmission method pertaining to the present invention will be described in detail below, taking into consideration the drawings which illustrate embodiments thereof.

Specific embodiments of the polishing method, the polishing apparatus and the method of manufacturing a semiconductor device according to the present invention will be described in detail below referring to the drawings.

The polishing method according to the present invention includes, in planarizing a metallic film, for example, a copper (Cu) film formed on a substrate and having unevenness, the steps of performing electropolishing with the metallic film on the substrate as the object of polishing, and simultaneously wiping the surface of the metallic film by sliding a pad on the metallic film surface. Incidentally, the following description will be made by taking as an example the case where the metallic film is a Cu film.

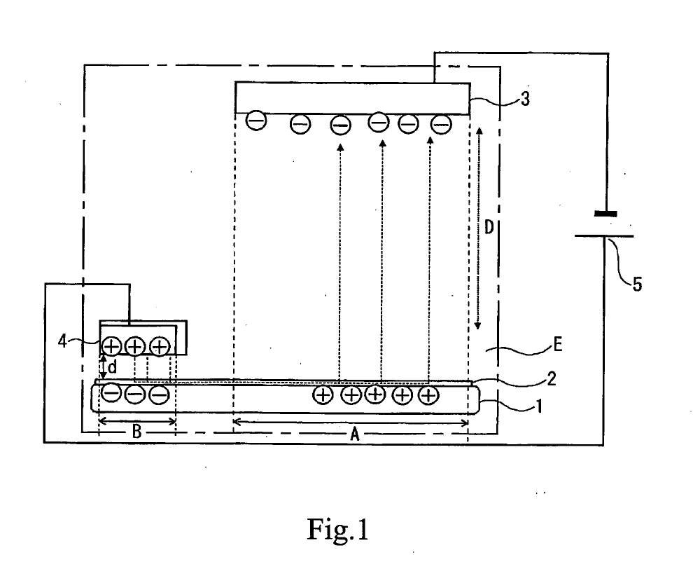

As shown in FIG. 1, the electropolishing is conducted by disposing a metallic film 2, which is the object of polishing formed on a substrate 1 and serves as anode in passing an electric current, and a opposite electrode (cathode) 3 oppositely to each other in an electrolytic solution E, and passing an electric current through an electrolyte by supplying an electrolytic voltage between the Cu film 2 and the opposite electrode 3 through the electrolytic solution E. By the electropolishing, the surface of the Cu film 2 subjected to an electrolytic action as anode is anodically oxidized, and a copper oxide coating is formed at the surface layer thereof. Besides, the oxide and a copper complex forming agent contained in the electrolytic solution E react with each other (to form the complex), whereby a denatured film such as a high electric resistance layer, an insoluble complex coating, and a passivation coating is formed from the complex forming agent substance on the surface of the Cu film 2. In the polishing method according to the present invention, as shown in the figure, the electropolishing is carried out by disposing the Cu film 2 in the vicinity of the peripheral edge of the Cu film 2 and oppositely to the Cu film 2, and passing an electric current to the Cu film 2 by use of an anode 4 being out of contact with the Cu film 2. The anode 4 is disposed at at least one location in the vicinity of the peripheral edge of the Cu film 2.

In the case where the non-contact type anode 4 is thus used, when the anode 4 is so disposed that the distance d between the Cu film 2 and the anode 4 is overwhelmingly smaller than the distance D between the Cu film 2 and the opposite electrode 3, a portion (region A in FIG. 1), opposed to the opposite electrode 3, of the Cu film 2 serves as anode to receive the electrolytic action, whereas a portion (region B in FIG. 1), opposed to the anode 4, of the Cu film 2 serves apparently as anode to receive the electrolytic action. With this depolarization into the region A where the Cu film 2 serves as anode to receive the electrolytic action and the region B where the Cu film 2 serves as cathode to receive the electrolytic action, the electric current through an electrolyte can be passed from an electrolytic power source 5 through the electrolytic solution E between the opposite electrode 3 and the region A and between the anode 4 and the region B, whereby the electropolishing can be caused to proceed.

Where electropolishing is conducted by passing the electric current through an electrolyte by use of the non-contact type anode 4, electrons are concentrated into the region B of the Cu film 2 opposed to the anode 4 and serving as cathode to receive the electrolytic action, and cations in the electrolytic solution will be deposited on the region B of the Cu film 2; for example, where copper ions are present in the electrolytic solution, copper will be deposited on the region B of the Cu film 2. For this reason, the electropolishing proceeds while the region B of the Cu film 2 remains due to the deposition of the cations. Therefore, in the above-mentioned polishing method, the electropolishing can be made to proceed to the end point without the problem that the Cu film 2 in the region B for passing the electric current to the anode 4 might be precedingly dissolved during the electropolishing to make it impossible to pass the electric current in the course of polishing. Incidentally, contrary to the above-mentioned region B of the Cu film 2, the region A of the Cu film 2 opposed to the opposite electrode 3 and serving as anode to receive the electrolytic action is deprived of electrons by the Cu film 2 in the region B, so that the surface thereof is anodically oxidized to form the above-mentioned denatured layer.

In addition, by conducting the electropolishing by use of the non-contact type anode 4, concentration of electrolysis due to mechanical causes such as scratches, flaws, cuts, etc. due to contact or sliding between the Cu film 2 and the anode 4 or electrochemical causes such as sparks, electro-corrosion, etc. is prevented from occurring, and it is possible to pass the electric current with a uniform current density distribution.

In the polishing method according to the present invention, wiping of the surface of the Cu film 2 with a pad is conducted simultaneously with the above-mentioned electropolishing. The wiping consists in sliding the pad on the surface of the Cu film 2 having been anodically oxidized, thereby to remove the denatured layer coating present at the surface layer of projected portions of the Cu film 2 having an unevenness, to expose the Cu therebeneath, and to cause re-electrolysis of the exposed Cu portions. This cycle of electropolishing and wiping is repeatedly conducted, whereby planarization of the Cu film 2 formed on the substrate 1 is made to proceed.

In the wiping, there is used such a pad that the area of contact between the pad and the Cu film 2 is smaller than the area of the Cu film 2 on the substrate 1 serving as the object of polishing. Therefore, the wiping is conducted in the condition where a part of the Cu film 2 is always protruding outwards from the area of the pad. Incidentally, the wiping is conducted under the condition where the above-mentioned anode 4 is disposed over the portion protruding outwards from the pad, for example, over a peripheral edge portion of the Cu film 2, and the pad is slid on the Cu film 2 in other area than the area where the anode 4 is disposed, i.e., while avoiding the layout position of the anode 4. Therefore, in the above-described polishing method, the anode 4 for passing the electric current can be disposed over the surface to be polished of the Cu film 2 serving as the object of polishing, and the wiping is not inhibited by the anode 4 disposed over the surface to be polished.

In addition, the wiping is conducted while driving, for example rotating, the pad itself. Besides, at the time of wiping, the substrate 1 is also driven to rotate, in the direction opposite to the driving direction of the pad.

In the above-mentioned wiping, with the substrate 1 rotated, uniform polishing is conducted over the whole surface of the Cu film 2 formed on the substrate 1. Namely, while the wiping is conducted by sliding the pad on the Cu film 2 in other area than the area where the anode 4 is disposed, the rotation of the substrate 1 enables sequential changeover between the peripheral edge portion where the anode 4 is disposed and the sliding range of the pad is not located and the peripheral edge portion where the sliding range of the pad is located, so that uniform polishing can be conducted over the whole surface of the Cu film 2. In addition, even where the substrate 1 is rotated, the anode 4 for passing the electric current to the Cu film 2 is out of contact with the Cu film 2 as above-described, so that concentration of electrolysis due to mechanical causes such as scratches, flaws, cuts, etc. at the contact point between the Cu film 2 and the anode 4 or electrochemical causes such as sparks, electro-corrosion, etc. is obviated, and the passage of the electric current is prevented from becoming impossible due to, for example, complete losing of the Cu film 2 at the current passage portion precedent to the end point of polishing. Therefore, according to the present polishing method, the passage of the electric current can be conducted up to the completion of polishing, the electropolishing proceeds favorably, and remaining of Cu on the inner circumferential side and the like trouble can be prevented from occurring.

In the polishing method in which electropolishing and wiping are conducted simultaneously as above-described, it suffices that the Cu film 2 and the anode 4 are out of contact with each other at least only at the time of passing the electric current. Therefore, the electric current may be passed to the Cu film 2 by an anode 4 which is always out of contact with the Cu film 2, specifically, which is out of contact with the Cu film 2 before, during, and after the polishing, or the electric current may be passed to the Cu film 2 by an anode 4 which is out of contact with the Cu film 2 only during the polishing when the current must be passed to the Cu film 2. In order to pass the electric current in the non-contact condition only during the polishing, for example, there is utilized a dynamic pressure of the electrolytic solution flowing into the gap between the anode 4 and the substrate 1 attendant on the rotation of the substrate 1. The dynamic pressure effect of the electrolytic solution levitates the anode 4 from the Cu film 2 by a tiny distance, whereby it is possible to set the Cu film 2 and the anode 4 out of contact with each other at the start of polishing. Incidentally, the levitation amount of the anode 4 can be regulated by the flow rate of the electrolytic solution, which is determined by the viscosity of the electrolytic solution and the rotating speed of the substrate 1, and the shape of the anode 4. By stably maintaining the levitation amount of the anode 4, the electric current through an electrolyte can be passed to the Cu film 2 with a stable electric resistance.

By polishing the Cu film 2 by the above-described polishing method, the electric current is passed stably and with a uniform current density distribution, whereby the electropolishing can be performed under favorable polishing rate and polishing conditions. In addition, the current passage portion between the Cu film 2 and the anode 4 would not be precedingly dissolved before completion of polishing, and the electropolishing can be made to proceed favorably up to the end point of polishing. Therefore, in the above-described polishing method, such problems remaining of Cu and over-polishing can be prevented from being generated.

In addition, in the polishing method as above, the anode 4 is disposed on the side of the surface to be polished of the Cu film 2, and the wiping is conducted by sliding the pad on the Cu film 2 in other area than the area where the anode 4 is disposed, so that the anode 4 does not hinder the wiping, and the electropolishing and the wiping can be conducted simultaneously and favorably. Therefore, the anode 4 can be disposed on the surface to be polished of the Cu film 2, and it is unnecessary to take into account contamination between itself and other apparatuses, modifications in the method of forming the Cu film 2 on the substrate 1 or the like, unlike in the case where, for example, the Cu film 2 is formed also on the back side of the substrate 1 and the current is passed from the back side.

Incidentally, the polishing method as above is also applicable to the case where an electropolishing medium based on a CMP slurry containing abrasive grains and rendered electrically conductive is substituted for the electrolytic solution, for enhancing the planarizing capability.

Besides, while the above polishing method has been described referring to the case where the electrolytic solution E containing a complex forming agent is used to form the denatured layer on the surface of the Cu film 2 through electropolishing and the denatured layer is wiped away to thereby polish the Cu film 2, there may be adopted a system in which Cu is dissolved out of the Cu film 2 by electropolishing to thereby polish the Cu film 2.

The polishing method as above can be applied to a polishing step in which the unevenness of a metallic film formed for filling up wiring trenches is planarized by polishing so as to form metallic wirings, in the manufacture of a semiconductor device. Now, the method of manufacturing a semiconductor device in which the above-described polishing method is carried out in the manufacturing process will be described below. The method of manufacturing a semiconductor device resides in forming metallic wirings composed of Cu by use of the so-called Damascene process. Incidentally, while the following description will be made referring to the formation of Cu wirings in a dual Damascene structure in which wiring trenches and contact holes are processed simultaneously, it is natural that the method of manufacturing a semiconductor device be also applicable to the formation of Cu wirings in a single Damascene structure in which only wiring trenches or connection holes are formed.

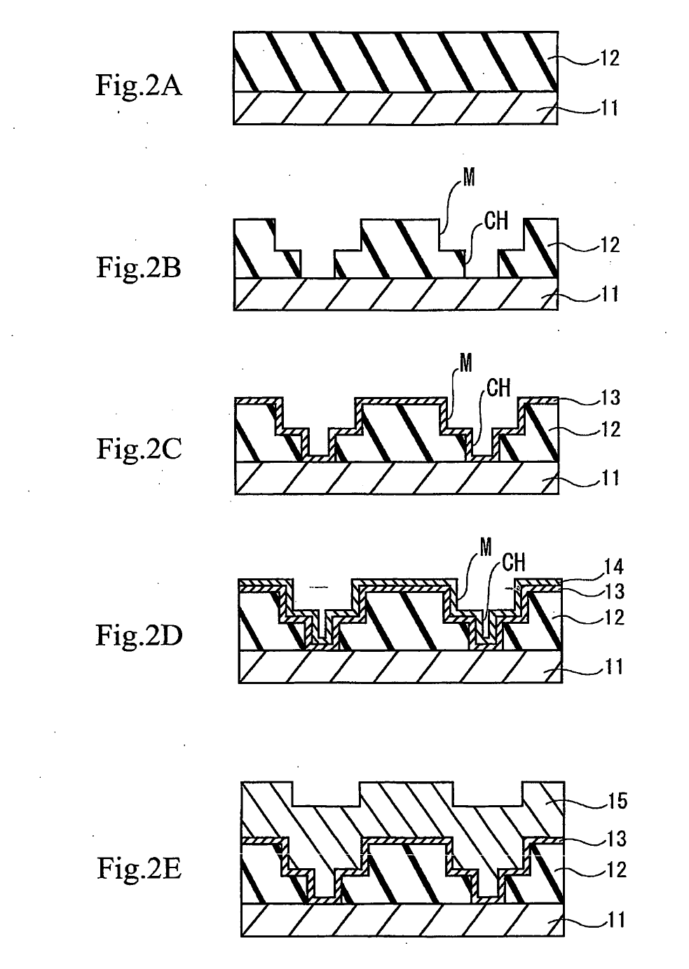

First, as shown in FIG. 2A, an inter-layer insulation film 12 formed of a low dielectric constant material such as porous silica is formed on a wafer substrate 11 formed of silicon or the like. The inter-layer insulation film 12 is formed, for example, by a vacuum CVD (Chemical Vapor Deposition) method.

Next, as shown in FIG. 2B, contact holes CH and wiring trenches M communicated with the impurity diffusion region (not shown) of the wafer substrate 11 are formed by use of, for example, the known photolithographic technique and etching technique.

Subsequently, as shown in FIG. 2C, a barrier metal film 13 is formed on the inter-layer insulation film 12 and in the contact holes CH and the wiring trenches M. The barrier metal film 13 is formed, for example, by a PVD (Physical Vapor Deposition) method using a material such as Ta, Ti, W, Co, TaN, TiN, WN, CoW, and CoWP and a sputtering apparatus, a vacuum deposition apparatus or the like. The barrier metal film 13 is formed for the purpose of preventing diffusion of Cu into the inter-layer insulation film 12.

After the formation of the barrier metal film 13 as above-mentioned, the wiring trenches M and the contact holes CH are filled up with Cu. The filling with Cu can be carried out by any of various kinds of known techniques conventionally used, for example, an electroplating method, a CVD method, a sputtering-and-flow method, a high-pressure reflow method, an electroless plating method or the like. Incidentally, from the viewpoints of film formation rate, film formation cost, the purity of the metallic material formed, adhesion performance and the like, it is preferably to carry out the filling with Cu by the electroplating method. Where the filling with Cu is conducted by the electroplating method, as shown in FIG. 2D, a seed film 14 formed of the same material as the wiring forming material, i.e., Cu, is formed on the barrier metal film 13 by a sputtering method or the like. The seed film 14 is formed for the purpose of accelerating the growth of copper grains when the wiring trenches M and the contact holes CH are filled up with Cu.

The filling of the wiring trenches M and the contact holes CH with Cu is carried out by forming a Cu film 15 over the whole area on the inter-layer insulation film 12 inclusive of the inside of the wiring trenches M and the contact holes CH by any of the above-mentioned various methods, as shown in FIG. 2E. The Cu film 15 is formed to have a film thickness of not less than the depth of the wiring trenches M and the contact holes CH, and is formed on the inter-layer insulation film 12 having the steps of the wiring trenches M and the contact holes CH, so that the Cu film 15 has steps according to the pattern of the steps present in the inter-layer insulation films 12. Incidentally, where the filling with Cu is carried out by the electroplating method, the seed film 14 formed on the barrier metal film 13 is integrated with the Cu film 15.

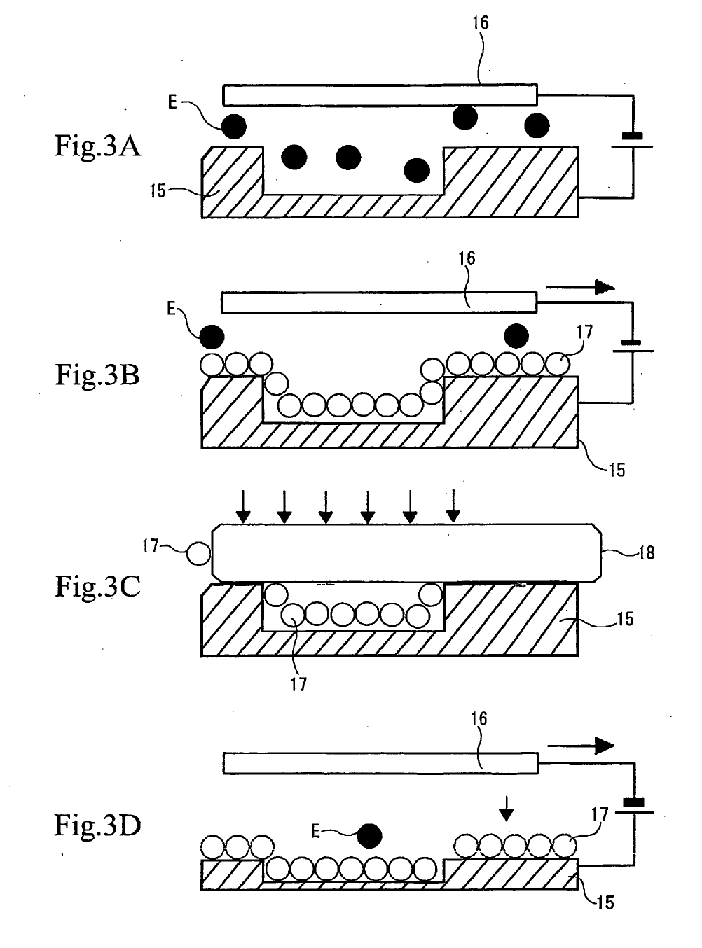

Subsequently, a polishing step is applied to the wafer substrate 11 provided thereon with the Cu film 15 as above-described. In the polishing step, the above-described polishing method in which electropolishing and wiping with a pad are simultaneously conducted is carried out. Specifically, as shown in FIG. 3A, an electric current is passed by use of an anode set out of contact with the Cu film 15, a opposite electrode 16 opposed to the Cu film 15 and the Cu film 15 are disposed in an electrolytic solution E, and, as shown in FIG. 3B, an electric current through an electrolyte is passed to perform electropolishing, whereby the surface of the Cu film 15 is anodically oxidized, and a denatured layer composed of an insoluble complex 17 of copper oxide is formed. Simultaneously, as shown in FIG. 3C, wiping is conducted by sliding a pad 18 while pressing the pad 18 with a predetermined pressure, specifically, a pressure of not more than 140 g/cm² which is the breaking pressure of the inter-layer insulation film 12 formed of porous silica, to remove the denatured layer composed of the insoluble complex 17, thereby exposing the copper underlying the Cu film 15. Upon the wiping with the pad 18, only the denatured layer on projected portions of the Cu film 15 is removed, whereas the denatured layer on recessed portions of the Cu film 15 is left as it is. Then, the electropolishing is made to proceed, to anodically oxidize the underlying copper further, as shown in FIG. 3D. In this case, since the denatured layer composed of the insoluble complex 17 remains on the recessed portions of the Cu film 15 as above-mentioned, the electropolishing does not proceed there, and, as a result, only the projected portions of the Cu film 15 are polished. Thus, the formation of the denatured layer by electropolishing and the removal of the denatured layer by wiping are conducted repeatedly, whereby the Cu film 15 is planarized and Cu wirings are formed in the wiring trenches M and the contact holes CH.

In the manufacture of a semiconductor device, after the above-described polishing step, polishing of the barrier metal film 13 and cleaning are conducted, and a cap film is formed on the wafer substrate 11 provided with the Cu wirings. Then, the steps ranging from the formation of the inter-layer insulation film 12 (illustrated by FIG. 2A) to the formation of the cap film as above-mentioned are repeated, to produce a multi-layer structure.

As has been described above, by carrying out the polishing method of performing the electropolishing and the wiping during the semiconductor device manufacturing process, an electric current is passed stably and with a uniform current density distribution, and planarization of the Cu film 15 is contrived by the electropolishing which proceeds under the favorable polishing rate and polishing conditions up to the end point of polishing; therefore, such problems as remaining of Cu and over-polishing are prevented from occurring. Accordingly, such defects as shortcircuit and opening of the Cu wirings can be restrained from being generated, and it is possible to form a surface which is smooth and has a stable wiring electric resistance.

In addition, since the electropolishing and the wiping are conducted simultaneously and favorably while the anode is disposed on the side of the surface to be polished of the Cu film 15, it is unnecessary to take into account contamination between itself and other apparatuses or modifications in the method of forming the Cu film 15 on the wafer substrate 11, and the semiconductor device can be manufactured by using the same Cu film forming apparatus and post-polishing cleaning apparatus as those conventionally used and by using the conventional semiconductor device manufacturing process flow, unlike in the case where, for example, the Cu film 15 is formed also on the back side of the wafer substrate 11 and the electric current is passed from the back side.

Furthermore, since the wiping of the denatured layer is conducted with a pressing pressure lower than that in CMP, specifically, with a pressing pressure lower than the breaking pressure of the inter-layer insulation film 12 formed from a low dielectric constant material such as porous silica and having a low strength, breakage of the inter-layer insulation film 12 such as exfoliation and cracking is prevented from occurring. In addition, since the anode for passing the electric current to the Cu film 15 is in a non-contact state, no pressure is exerted on the inter-layer insulation film 12, so that the inter-layer insulation film 12 is prevented from undergoing exfoliation, cracking or the like. Therefore, favorable wiring formation can be achieved even where a low dielectric constant film with low strength is used as the inter-layer insulation film 12.

Incidentally, the above-described method of manufacturing a semiconductor device can be applied also to the case where an electropolishing medium based on a CMP slurry containing abrasive grains and rendered electrically conductive is substituted for the electrolytic solution in the above-described polishing step for the purpose of enhancing the planarizing capability.

Besides, the above-described polishing method in which electropolishing is conducted by passing an electric current through the electrolytic solution by the anode serving as the current passing electrode set in a non-contact state can naturally be carried out not only in the polishing step in manufacture of a semiconductor device but also in all kinds of other manufacturing processes including a step of polishing a metallic film.

The polishing apparatus for use in the above-described polishing method and in the polishing step in the method of manufacturing a semiconductor device will be described.

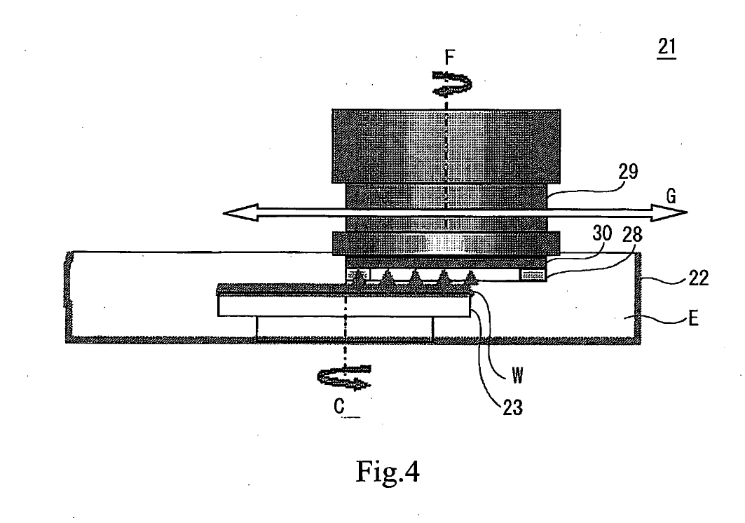

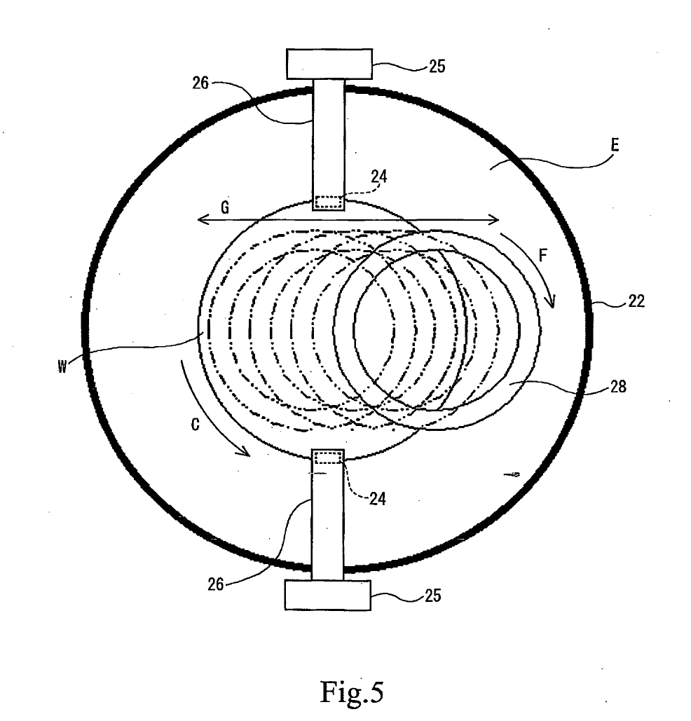

As shown in FIGS. 4 and 5, in the polishing apparatus 21, a wafer chuck 23 for chucking a semiconductor wafer W including a Cu film 15 formed on a wafer substrate 11 as above-described is disposed in an electrolytic tank 22 filled with an electrolytic solution E. The wafer chuck 23 is driven to rotate in the direction of arrow C in the electrolytic tank 22 by a drive motor which is omitted in the figure. In the wafer chuck 23, the wafer W is held under suction by a vacuum suction means, for example.

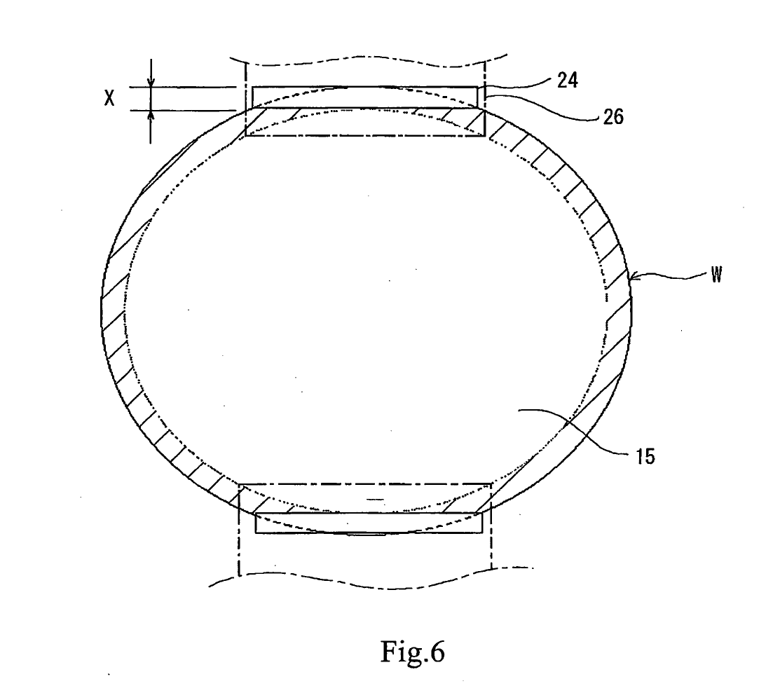

On the Cu film 15 of the semiconductor wafer W held under suction by the wafer chuck 23, a pair of anode portions 24 are disposed in the vicinity of the peripheral edge thereof, as shown in FIG. 6. Thus, the pair of anode portions 24 are so disposed as to overlap the Cu film 15 over a current passage area (hatched in the figure) with a predetermined width X, for example, 5 mm in the vicinity of the peripheral edge, with the result that the overlapping portion has an area of about 10% based on the whole circumference of the contact area and that a sufficient electric current through an electrolyte can be passed to the Cu film 15.

The anode portion 24 is supported by a first arm 25 for moving the anode portion 24 in the direction perpendicular to the surface to be polished of the Cu film 15 and a second arm 26 for moving the anode portion 24 in the direction horizontal to the surface to be polished, and is disposed at the tip end of the second arm 26 through an elastic member which will be described later. In the polishing apparatus 21, the pressing pressure of the anode portion 24 is regulated by the first arm 25 so that the anode portion 24 is levitated into a non-contact state over and in proximity to the Cu film 15 when the semiconductor wafer W is rotated. In addition, in the polishing apparatus 21, at the times of loading and unloading the semiconductor wafer W onto and from the wafer chuck 23, the anode portion 24 is moved by the second arm 26 to a retracted position for letting free the upper side of the wafer chuck 23. Therefore, the wafer W can be loaded and unloaded via the upper side of the wafer chuck 23.

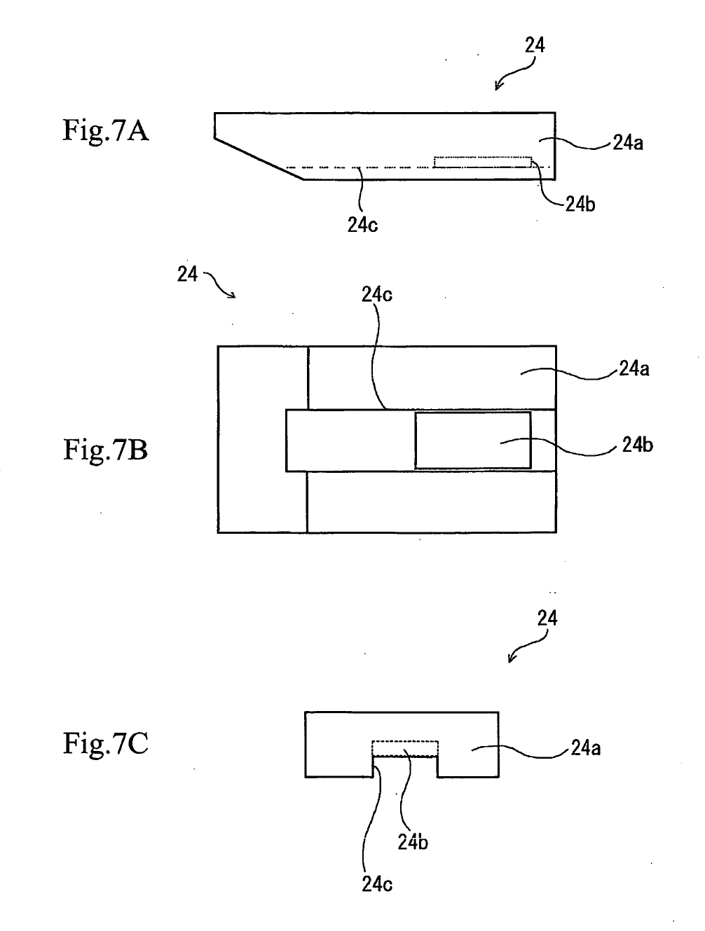

As shown in FIGS. 7A, 7B, and 7C, the anode portion 24 is composed of a slider main body 24a, and an anode 24b disposed at the slider main body 24a. The slider main body 24a is formed of an insulating material, and is formed in the shape of a parallelepiped in which one side portion of the lower surface, specifically, a surface thereof opposed to the Cu film 15 is cut out. The lower surface of the slider main body 24a is provided with a groove 24c, and the anode 24b is embedded so that one surface thereof fronts on the groove 24c. As the material of the anode 24b, there may be used copper, silver, a sintered copper alloy, carbon or the like.

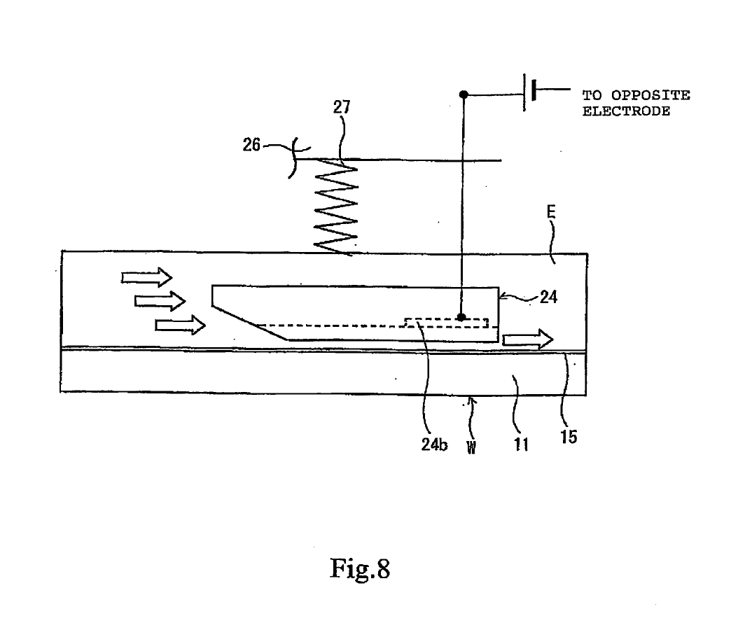

The anode portion 24 is disposed on the current passage area in the vicinity of the peripheral edge of the Cu film 15 as above-mentioned, in such a manner that it is supported on the second arm 26 through an elastic member, for example, a spring 27 and that the cutout portion is located on the upstream side with respect to the rotating direction of the semiconductor wafer W, as shown in FIG. 8. At the time of polishing when the semiconductor wafer W is rotated, the anode portion 24 is levitated by a minute distance, for example, about 5 μm, by utilizing the dynamic pressure effect of the electrolytic solution E flowing into the gap between the anode portion 24 and the semiconductor wafer W via the cutout in the slider main body 24a, whereby the anode portion 24 is set out of contact with the Cu film 15. The levitation amount of the anode portion 24 is arbitrarily controlled by the flow rate of the electrolytic solution E, which is determined by the viscosity of the electrolytic solution E and the rotating speed of the semiconductor wafer W, the shape of the slider main body 24a, and the like. By maintaining a stable levitation amount of the anode 24b, the electric current through an electrolyte can be passed to the Cu film 15 on the semiconductor wafer W with a stable electric resistance. Incidentally, when the current passage is not effected and the semiconductor wafer W is stopped, the anode portion 24 is in contact with the semiconductor wafer W; however, since the lower surface side of the slider main body 24a is so formed that the contact between the semiconductor wafer W and the anode portion 24 occurs sufficiently smoothly, the Cu film 15 on the semiconductor wafer W would not be damaged.

In addition, as shown in FIGS. 4 and 5, the polishing apparatus 21 is provided with a pad holding mechanism 29 in which the pad 28 is disposed on a surface thereof on the side of the electrolytic tank 22. The pad 28 is annular in shape, and is formed to be smaller in diameter than the semiconductor wafer W. The pad 28 is rotated in the direction of arrow F in the state of being held by the pad holding mechanism 29, and is driven to reciprocate in the direction of arrows G while sliding on the Cu film 15 in an area other than the layout positions of the anode portions 24. In addition, the pad holding mechanism 29 is equipped with a opposite electrode 30 between itself and the pad 28. In the polishing apparatus 21, the opposite electrode 30 is disposed oppositely to the semiconductor wafer W with a predetermined interval therebetween, in the electrolytic solution E.

In the polishing apparatus 21 as above, the Cu film 15 on the semiconductor wafer W is electropolished by passing an electric current to the Cu film 15 serving as anode by the anode portions 24, and, simultaneously with the electropolishing, wiping is conducted with the pad 28 sliding on the Cu film 15 through moving in the direction of arrows G while rotating. The wiping with the pad 28 is carried out with a pressing pressure of not less than 140 g/cm² which is the breaking pressure of the inter-layer insulation film formed of a low dielectric constant material such as porous silica.

By thus passing the electric current to the Cu film 15 by use of the anode portions 24 set out of contact with the Cu film 15, the electric current can be passed stably and with a uniform current density distribution, whereby electropolishing is conducted under favorable polishing rate and polishing conditions. In addition, precedent dissolution of the current passage portions between the Cu film 2 and the anodes 4 before completion of polishing is obviated, and the electropolishing proceeds favorably up to the end point of polishing. Therefore, in the polishing apparatus 31 as above-described, such problems as remaining of Cu and over-polishing are prevented from occurring, such defects as shortcircuit and opening of the Cu wirings can be restrained from being generated, and it is possible to form a surface which is smooth and has a stable wiring electric resistance.

In addition, in the polishing apparatus 21, since the electropolishing and the wiping are conducted simultaneously and favorably while the anodes 4 are disposed on the side of the surface to be polished of the Cu film 15, it is unnecessary to take into account contamination between itself and other apparatuses, and a semiconductor device can be manufactured by using the same Cu film forming apparatus and post-polishing cleaning apparatus as those conventionally used and using the conventional semiconductor device manufacturing process flow, unlike in the case where, for example, the Cu film 15 is formed also on the back side of the wafer substrate 11 and the electric current is passed from the back side.

Furthermore, the wiping of the denatured layer is carried out with a pressing pressure of not more than the breaking pressure of the inter-layer insulation film formed of a low dielectric constant material and having a low strength. Therefore, in the polishing apparatus 21, unlike in the case of polishing by CMP, breakage of the inter-layer insulation film such as exfoliation and cracking would not occur, and, as a result, a favorable wiring formation can be achieved. Besides, since the anodes for passing an electric current to the Cu film 15 is out of contact with the Cu film 15, the passage of the electric current to the Cu film 15 does not involve application of a pressure to the inter-layer insulation film, so that the inter-layer insulation film does not undergo exfoliation, cracking or the like.

The polishing apparatus according to the present invention is not limited to the above-described configuration but may have other configuration. Now, polishing apparatuses of other configurations will be described. Incidentally, in the following description, the same members as those in the above-described polishing apparatus 21 will be denoted by the same symbols as used above, and detailed description thereof will be omitted.

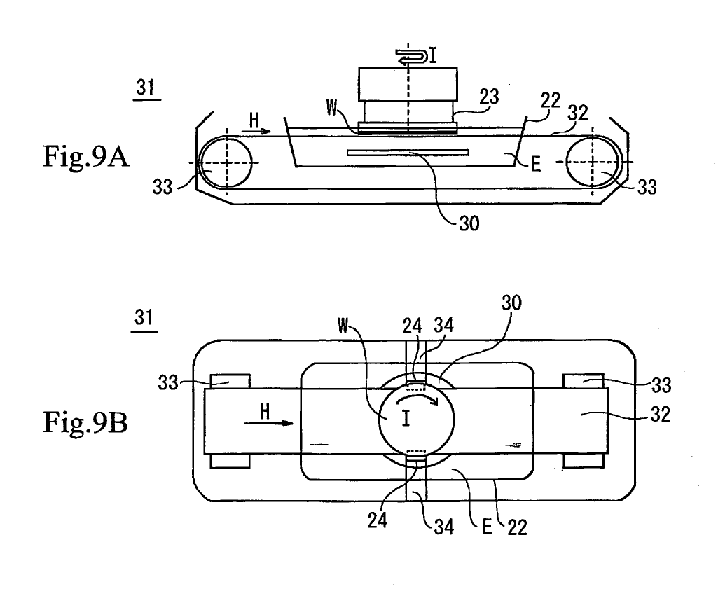

As shown in FIGS. 9A and 9B, a polishing apparatus 31 is for polishing a semiconductor wafer W held face-down under suction by a wafer chuck 23, by use of a belt-type pad 32. The pad 32 is ring-like in shape, is driven by a pair of drive rollers 33, and is moved in the direction of arrow H. In addition, the pad 32 is formed to be smaller in width than the semiconductor wafer W, by about 5 mm on both sides. An electrolytic tank 22 charged with an electrolytic solution E is disposed on the moving path of the pad 32, and a opposite electrode 30 is disposed oppositely to the semiconductor wafer W, with the pad 32 therebetween, in the electrolytic tank 22.

In the polishing apparatus 31, wiping is conducted while the semiconductor wafer W held face-down under suction is pressed against the pad 32 which is moved while being rotated in the direction of arrow I. Electropolishing is conducted by passing an electric current by anode portions 24 disposed, in the state of being supported by arms 34, at peripheral edge portions of the semiconductor wafer W protruding outwards from the pad 32. In this case, the anode portions 24 are levitated attendant on the rotation of the semiconductor wafer W, so that the passage of the electric current is conducted in the condition where the anode portions 24 are out of contact with the Cu film on the semiconductor wafer W.

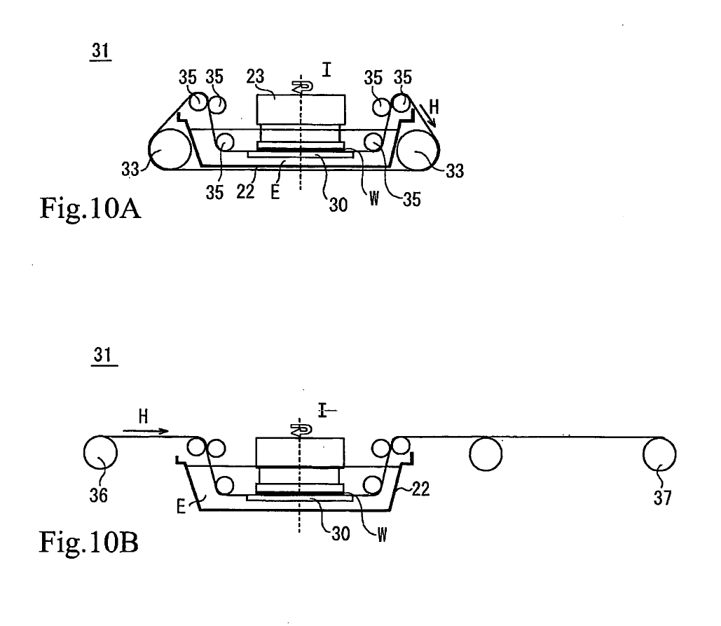

Besides, the above-described polishing apparatus 31 may be have the configuration shown in FIG. 10A in which the pad 32 is moved via a plurality of guide rolls 35, or may have the configuration shown in FIG. 10B in which the pad 32 is not ring-like in shape and not moved in an endless manner but is let off by a let-off roller 36 and is taken up by a take-up roll 37.

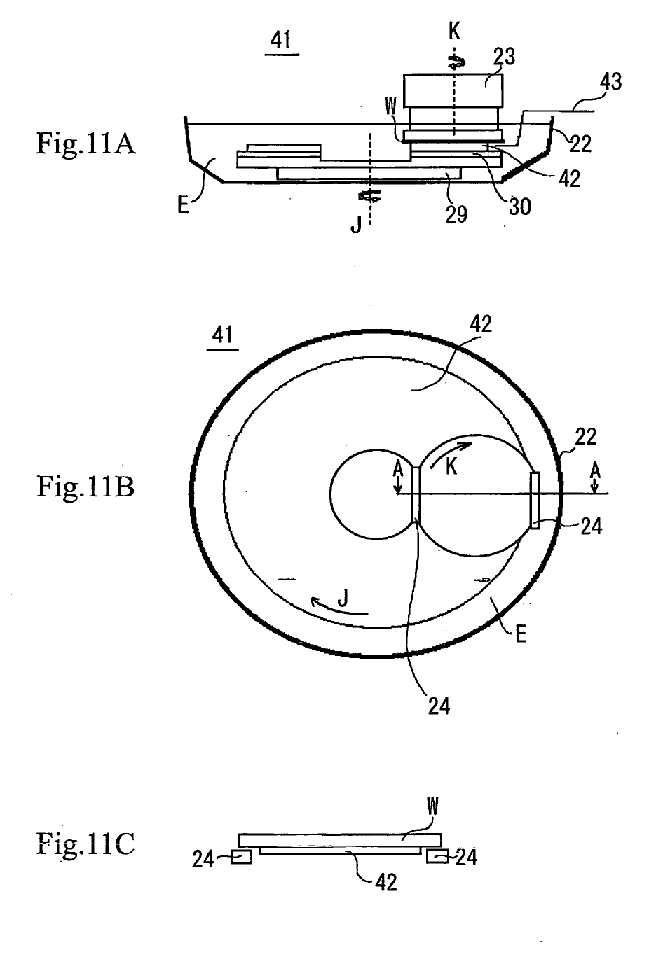

Next, a polishing apparatus 41 having still another configuration will be described. As shown in FIGS. 11A and 11B, the polishing apparatus 41 is for polishing, by an annular-type pad 42, a semiconductor wafer W held face-down under suction by a wafer chuck 23. The pad 42 is held by a pad holding mechanism 29 in an electrolytic tank 22 charged with an electrolytic solution E, and is driven to rotate in the direction of arrow J. In addition, the width from the inner circumference to the outer circumference of the pad 42 is smaller than the semiconductor wafer W, by about 5 mm on both sides. The pad holding mechanism 29 is equipped with a opposite electrode 30 between itself and the pad 42.

In the polishing apparatus 41, the semiconductor wafer W held face-down under suction, while rotating in the direction of arrow K, is pressed against the pad 42 rotated in the direction of arrow J, whereby wiping is conducted. Electropolishing is conducted by passing an electric current by anode portions 24 supported by an arm 43 at a peripheral edge portion of the semiconductor wafer W protruding outwards from the pad 42. In this case, the anode portions 24 are levitated attendant on the rotation of the semiconductor wafer W as shown in FIG. 11C, so that the electric current is passed to a Cu film on the semiconductor wafer W in the condition where the anode portions 24 are out of contact with the Cu film.

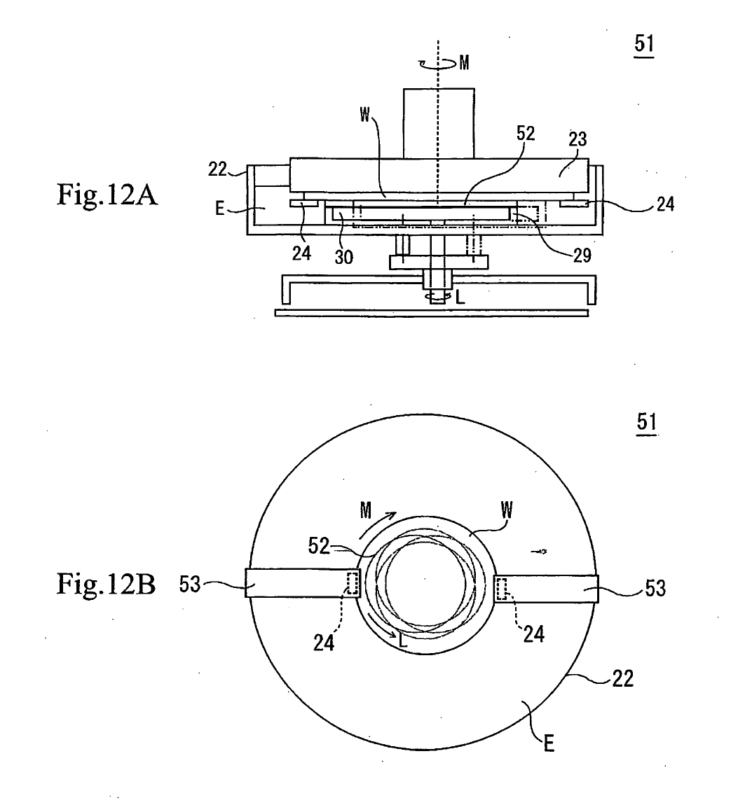

Next, a polishing apparatus 51 having a still further configuration will be described. As shown in FIGS. 12A and 12B, the polishing apparatus 51 is for polishing, with a pad 52, a semiconductor wafer W held face-down under suction by a wafer chuck 23. The pad 52, in the state of being held by a pad holding mechanism 29 in an electrolytic tank 22 charged with an electrolytic solution E, is rotated in the direction of arrow L and is driven to perform a planetary motion such as to draw small circles. In addition, the pad 52 is formed to be smaller in diameter than the semiconductor wafer W, by about 5 mm on both sides. The pad holding mechanism 29 is equipped with a opposite electrode 30 between itself and the pad 52.

In this polishing apparatus 51, wiping is conducted in the condition where the semiconductor wafer W held face-down under suction is, while rotating in the direction of arrow M, pressed against the pad 52 rotated in the direction of arrow L and performing the planetary motion. Electropolishing is conducted by passing an electric current by anode portions 24 supported by arms 53 at peripheral edge portions of the semiconductor wafer W protruding outwards from the pad 52. In this case, the anode portions 24 are levitated attendant on the rotation of the semiconductor wafer W, so that the electric current is passed to a Cu film on the semiconductor wafer W in the condition where the anode portions 24 are out of contact with the Cu film.

In the polishing apparatuses 31, 41, and 51 configured as above-described, like in the case of the above-described polishing apparatus 21, such problems as remaining of Cu and over-polishing are prevented from occurring, such defects as shortcircuit and opening of Cu wirings can be restrained from being generated, and it is possible to form a surface which is smooth and has a stable wiring electric resistance. In addition, a semiconductor device can be manufactured by using the same Cu film forming apparatus and post-polishing cleaning apparatus as those conventionally used and following the conventional semiconductor device manufacturing process flow.

### INDUSTRIAL APPLICABILITY

As has been described in detailed above, according to the polishing method and the polishing apparatus provided by the present invention, the electric current is passed to the metallic film by use of the current passing electrode set out of contact with the metallic film and the electropolishing is thereby conducted, whereby the metallic film at the current passing portion(s) can be left until the end point of polishing, the electropolishing of the metallic film can be made to proceed favorably, and such problems as remaining of the metallic film and over-polishing can be prevented from occurring.

In addition, according to the present invention, the pad smaller in diameter than the metallic film is used, and the current passing electrode is disposed at a peripheral edge portion of the metallic film protruding outwards from the area of the pad, whereby the current passing electrode disposed on the side of the surface to be polished does not inhibit the wiping, and the electropolishing and the wiping can be conducted simultaneously and favorably.

Furthermore, by the method of manufacturing a semiconductor device according to the present invention, like in the case of the above-described polishing method, electropolishing can be made to proceed favorably up to the end point of polishing, such problems as remaining of the metallic film and over-polishing can be prevented from occurring, and the electropolishing and the wiping can be conducted simultaneously and favorably. Therefore, according to the present invention, such defects as shortcircuit and opening of the metallic wirings can be restrained from being generated, and it is possible to form a surface which is smooth and has a stable wiring electric resistance. Besides, it is unnecessary to take into account contamination between the metallic film and other apparatuses, modifications in the method of forming the metallic film, or the like, and a semiconductor device can be manufactured by using the same film forming apparatus and post-polishing cleaning apparatus as those conventionally used and following the conventional semiconductor device manufacturing process flow.

Furthermore, according to the present invention, since the current passing electrode is used in a non-contact state and no pressure is exerted on the inter-layer insulation film at the time of passing the electric current, breakage of the inter-layer insulation film such as exfoliation and cracking can be prevented from occurring and a favorable wiring formation can be achieved, even where a low dielectric constant film formed of a low dielectric constant material such as porous silica and having a low strength is used as the inter-layer insulation film.

1. A polishing method comprising the steps of:
disposing a substrate provided thereon with a metallic film and a opposite electrode oppositely to each other with a predetermined interval therebetween in an electrolytic solution, and
passing an electric current to said metallic film through said electrolytic solution by a current passing electrode set out of contact with said metallic film so as to electropolish said metallic film.

2. A polishing method as set forth in claim 1, wherein said current passing electrode is disposed oppositely to said substrate and closer to said substrate than said opposite electrode.

3. A polishing method as set forth in claim 1, wherein said electrolytic solution contains a complex forming agent.

4. A polishing method as set forth in claim 1, wherein said metallic film is a copper film.

5. A polishing method as set forth in claim 3, wherein wiping by sliding a pad on said metallic film is conducted simultaneously with said electropolishing.

6. A polishing method as set forth in claim 5, wherein said pad is slid while avoiding the position where said current passing electrode is disposed.

7. A polishing method as set forth in claim 5, wherein said pad is smaller in diameter than said metallic film.

8. A polishing method as set forth in claim 7, wherein at least one said current passing electrode is disposed at a peripheral edge portion of said metallic film protruding outwards from the area of said pad.

9. A polishing method as set forth in claim 5, wherein said substrate is rotated during said wiping.

10. A polishing method as set forth in claim 9, wherein said rotation of said substrate causes said electrolytic solution to flow into the gap between said substrate and said current passing electrode, and said electrode passing electrode is levitated by the dynamic pressure of said electrolytic solution to get out of contact with said metallic film.

11. A polishing apparatus comprising, in an electrolytic solution:
a substrate provided thereon with a metallic film,
a opposite electrode disposed oppositely to said substrate with a predetermined interval therebetween, and
a current passing electrode set out of contact with said metallic film, wherein
an electric current is passed to said metallic film through said electrolytic solution by said current passing electrode so as to electropolish said metallic film.

12. A polishing apparatus as set forth in claim 11, comprising a pad slid on said metallic film.

13. A polishing apparatus as set forth in claim 12, wherein said substrate is driven to rotate when said pad is slid.

14. A polishing apparatus as set forth in claim 13, wherein
said current passing electrode is comprised of:
an electrode portion formed of an electrode material, and
a main body portion for covering said electrode portion,
at least one surface, opposite to said metallic film, of said electrode portion being exposed to the exterior,
said main body portion being so formed that one side portion of a surface thereof opposite to said metallic film is cut out, and
the cut-out side of said main body portion being located on the upstream side with respect of the rotating direction of said substrate.

15. A method of manufacturing a semiconductor device, comprising the steps of:
disposing a wafer substrate and a opposite electrode oppositely to each other with a predetermined interval therebetween in an electrolytic solution, said wafer substrate being provided thereon with a metallic film formed of a metallic wiring material so as to fill up connection holes or wiring trenches formed in an inter-layer insulation film or both of said connection holes and said wiring trenches, and
passing an electric current to said metallic film through said electrolytic solution by a current passing electrode set out of contact with said metallic film so as to electropolish said metallic film.

16. A method of manufacturing a semiconductor device as set forth in claim 15, wherein wiping by sliding a pad on said metallic film is conducted simultaneously with said electropolishing.

17. A method of manufacturing a semiconductor device as set forth in claim 16, wherein said wafer substrate is rotated during said wiping, the rotation of said substrate causes said electrolytic solution to flow into the gap between said substrate and said current passing electrode, and said current passing electrode is levitated by the dynamic pressure of said electrolytic solution to get out of contact with said metallic film.

18. A method of manufacturing a semiconductor device as set forth in claim 15, wherein said inter-layer insulation film is formed of a low dielectric constant material.
